(19) United States
(12) Patent Application Publication
(10) Pub. No.: US 2007/0194871 A1
(43) Pub. Date: Aug. 23, 2007

(54) Oscillating superconducting inductor electro-magnet motor

(76) Inventor: Barry D. Bourquin, Phillipsburg, NJ (US)

Correspondence Address: Donald W. Meeker;Patent Agent, 924 East Ocean Front #E, Newport Beach, CA, 92661, US

(21) Appl. No.: 11/709,470

(22) Filed: Feb. 22, 2007

Related U.S. Application Data
(60) Provisional application No. 60/776,165, filed on Feb. 23, 2006.

(51) Int. Cl. H01F 6/00

(52) U.S. Cl. 335/216

(57) ABSTRACT

A charged capacitor in a circuit with a superconducting inductor and switches creates oscillates direct current through the superconducting inductor to cause it to be a superconducting inductor electromagnet with oscillating polarity. Permanent magnets mounted on moving supports when placed in proximity to the polar ends of the superconducting electromagnet the magnets are moved by repulsion forces between like polarity and attraction forces with unlike polarity to move the moving support in continual motion which can be harnessed for work.

### CROSS-REFERENCE TO RELATED APPLICATIONS

The present utility patent application claims the benefit of provisional application No. 60/776,165, filed Feb. 23, 2006.

### STATEMENT REGARDING FEDERALLY SPONSORED RESEARCH OR DEVELOPMENT

Not Applicable.

### THE NAMES OF THE PARTIES TO A JOINT RESEARCH OR DEVELOPMENT

Not Applicable.

### BACKGROUND OF THE INVENTION

1. Field of the Invention

The present invention relates to electric motors and particularly to an oscillating superconducting inductor electromagnetic motor which is capable of generating continuous mechanical motion from the combined use of: superconducting wires kept at or below its critical temperature; an inductor constructed of superconducting wires kept at or below its critical temperature; a charged capacitor inserted between and connecting the two leads of the superconducting inductor creating an oscillation of direct electrical current in a persistent state across the inductor creating an electromagnet with alternating magnetic polarity; permanent magnets which when placed in proximity to the alternating magnetic polarity of the superconducting inductor electromagnet, causing repulsion forces between like magnetic poles and attraction forces between opposite magnetic poles which can be harnessed to perform mechanical motion; and switching devices inserted into the superconducting circuit to coordinate the alternating polarity of the superconducting inductor electromagnet with the proximity of the permanent magnets.

2. Description of Related Art Including Information Disclosed Under 37 CFR 1.97 and 1.98

Science teaches that gravity and magnetism are fields not forces, as forces can be converted to perform work, fields cannot. For instance if a rocket is launched into the air, the energy expended to propel the rocket away from the gravitational field of the earth will equal the energy given off in heat, light and kinetic energy on re-entry as gravity pulls the rocket back to earth. But as rockets are launched into space such that they break the gravitational pull of earth and travel into space, calculating the weight of the satellite and the speed, one can figure the kinetic energy of the satellite and should equal the amount of fuel expended to reach the attained velocity (discounting for the moment air friction and other smaller losses of energy). To gain speed, it is a practice to “slingshot” satellites around the moon or some other planet using their gravitational pull to give the satellite additional speed for its inter-planetary journey. If the satellite were brought back to earth it would then have more speed and kinetic energy than the fuel expended. Thus gravitational pull had to have imparted additional energy to the system. If gravity can be a force in that sense, so also magnetism can act as a force.

### BRIEF SUMMARY OF THE INVENTION

The motor device of the present invention generates mechanical motion by alternating polarity in a superconducting inductor electromagnet which when placed proximate to permanent magnets, creates oscillating push/pull forces capable of producing mechanical work. More specifically, an inductive coil when energized resists change in current, building up stored energy in a magnetic field. Once the magnetic field is built; current can flow normally through the inductor. Constructing the inductive coil from superconducting materials, and bringing the superconductive assembly to below critical temperature permits current to flow through the assembly without resistance. Connecting the two end leads of the superconducting inductor creates a loop of continuous current placing the assembly in persistence state. Persistence state being defined as a state of continuous current in a looped circuit without degradation of current due to wire resistance. A superconductive inductor in persistence state maintains a permanent magnetic field of stored energy about the inductor creating an electromagnet with magnetic poles at the ends of the coil.

The motor device of the present invention introduces a capacitor to the circuit. The assembly consists of a charged capacitor, a switch and a superconducting inductor. When the switch is closed completing the circuit, the capacitor will discharge through the superconductor inductor. As it does so, the inductor builds up stored energy in a magnetic field as it resist the change in the circuit's current flow. Once the magnetic field is built, current can flow normally through the coil. Once the capacitor is discharged, the current on the discharging side of the circuit drops off rapidly. The inductor will resist the change in current flow by collapsing the stored energy in the magnetic field thereby charging the other, opposite plate of the capacitor. Once the inductor's field collapses, the capacitor will be recharged (but with opposite polarity), so it will discharge again through the inductor in the opposite direction. This oscillation of current flow will continue as there is no energy loss to wire resistance in the superconductor assembly.

The oscillating capacitor/inductor assembly creates an electromagnet with alternating polarity. The motor device of this invention is created by placing a permanent magnet on either side of the oscillating superconductor inductor. The magnets are placed such that like poles face the oscillating polarity of the superconducting inductor/magnet. As polarity oscillates across the superconducting electromagnet, push/pull forces will be exerted on the permanent magnets. These forces caused by like magnetic poles repelling and opposite magnetic poles attracting. Connecting the permanent magnets through or about the superconductor capacitor/inductor assembly and placing the connected permanent magnet assembly to a slide mechanism, will cause the permanent magnet assembly to reciprocate in a linear mechanical motion as the inductor's polarity changes in response to the oscillating current through the superconducting inductor. Given the strong magnetic fields superconducting electromagnets can produce, the motor device of the present invention can produce significant amounts of mechanical push/pull forces which can be harnessed to produce work.

### BRIEF DESCRIPTION OF THE SEVERAL VIEWS OF THE DRAWINGS

These and other details of my invention will be described in connection with the accompanying drawings, which are furnished only by way of illustration and not in limitation of the invention, and in which drawings:

FIG. 1 is a side elevational view of an embodiment of the motor device of the present invention showing the oscillating superconducting inductor electromagnet centrally positioned with a pair of permanent magnets mounted on a sliding mechanism with one permanent magnet on each side of oscillating superconducting inductor electro-magnet with each permanent magnet having the same magnetic pole facing the oscillating superconducting inductor electromagnet so that the sliding mechanism produces a reciprocating linear motion;

FIG. 2 is a side elevational view of another embodiment of the motor device of the present invention showing the oscillating superconducting inductor electromagnet positioned adjacent to a rotatable cyclone shaped rotatable support for a pair of permanent magnets mounted with one permanent magnet on each flat perpendicular face at the end of two outwardly expanding elliptical edges with each permanent magnet having a different magnetic pole facing the oscillating superconducting inductor electro-magnet positioned on a pivot mount adjacent to the position of the permanent magnets mounted on the rotatable support so that alternating polarity of the superconducting inductor electromagnet continually repels each of the permanent magnets to maintain rotation of the cyclone shaped rotatable support;

FIG. 3 is a side elevational view of another embodiment of the motor device of the present invention showing the oscillating superconducting inductor electromagnet positioned adjacent to and below a rotatable circular wheel with a single permanent magnet mounted slidably in a slot across the circular wheel along a diagonal so that the repelling force created by a like polarity of the superconducting inductor electromagnet on a the sliding permanent magnet causes the permanent magnet to move up and out of the slot at an angle to the vertical to tip the balance of the rotatable circular wheel to cause rotation of the wheel and a re-centering wedge with a curved face adjacent to the circular wheel pushes the permanent magnet back into the slot for the oscillating superconducting inductor electromagnet to change polarity to repel the opposite pole of the permanent magnet and repeat the cycle for continual rotation of the circular wheel.

### DETAILED DESCRIPTION OF THE INVENTION

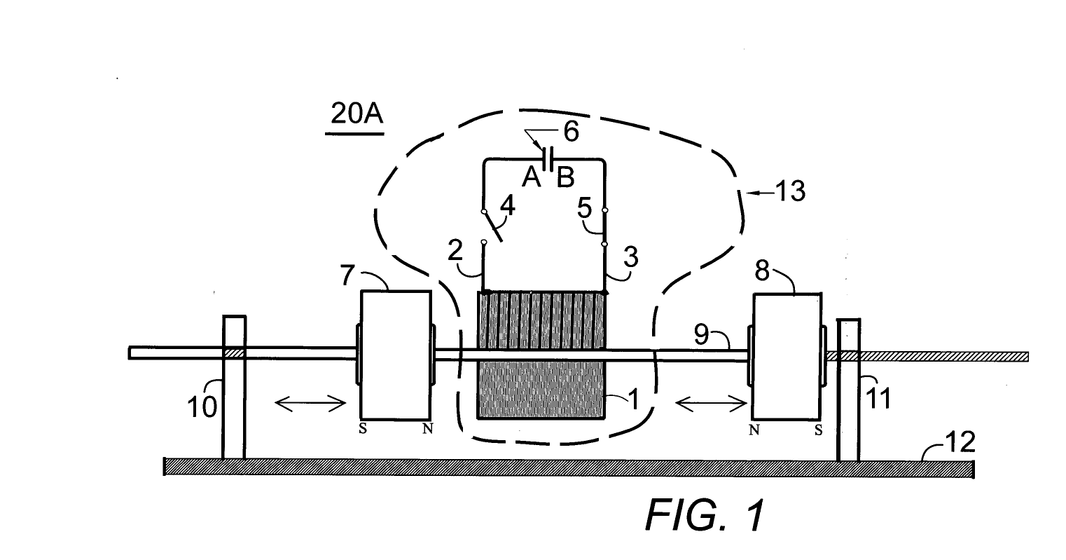

In FIGS. 1, 2, and 3, a motor device 20 for generating continuous mechanical motion from the interaction of a combination of components comprises a superconducting inductor 1 constructed of a superconducting coil kept at or below its critical temperature, superconducting wires connected to the superconducting inductor to form two leads 2, 3 from the superconducting inductor 1, a charged capacitor 6 inserted between and connecting the two leads 2, 3 of the superconducting inductor 1, the charged capacitor, superconducting wires, and superconducting inductor together forming a superconducting circuit or superconducting assembly 13, at least one permanent magnet 7, 8, and 7A and at least one switching device 4, 5 inserted into the superconducting circuit 13.

The superconducting wires that form the two leads 2, 3 and the superconducting inductor 1 are kept at or below their critical temperature to maintain their superconducting properties.

The charged capacitor 6 and the connected leads 2, 3 of the superconducting inductor 1 create a continual oscillation of direct electrical current across the inductor to form a superconducting inductor electromagnet 1 with alternating magnetic polarity which continually repel permanent magnets 7, 8 and 7A mounted on a movable support 9, 14A and 14B so that the repelled permanent magnets create a continual motion in the movable support.

In FIG. 1, in one embodiment, there are two permanent magnets 7, 8, mounted on a sliding support 9 riding on two supports 10 and 11 having bearings contacting the sliding support 9 with the permanent magnets 7, 8 placed in proximity to the alternating magnetic polarity of the superconducting inductor electromagnet 1, thereby causing repulsion forces between like magnetic poles of the permanent magnets 7, 8 and the superconducting inductor electro-magnet 1, and attraction forces between opposite magnetic poles of the permanent magnets 7, 8 and the superconducting inductor electro-magnet 1. The repulsion forces and attraction forces are harnessed to perform mechanical motion in the sliding support.

In FIG. 1, in one embodiment, two switching devices 4, 5 in the superconducting circuit coordinate the alternating polarity of the superconducting inductor electro-magnet 1 with the proximity of the permanent magnets 7, 8.

The charged capacitor 6 comprises two charging plates A and B, and the at least one switching device comprises a switching control for two switches 4 and 5, one connected to each of the two superconducting wire leads 2 and 3 from the superconducting inductor 1. The switching control activation causes a charged plate, say plate A of the capacitor 6 to become a discharging plate to discharge current through the superconducting inductor 1 to the opposite plate B of the capacitor 6 which becomes a charging plate and the superconducting inductor 1 resists the changes in current flow and builds up stored energy in the form of a magnetic field as current begins to flow through the superconducting inductor. Once the magnetic field is built, current flows normally through the superconducting inductor 1 to the opposite charging plate B of the capacitor and the superconducting inductor becomes a superconducting inductor electromagnet with north polarity being formed on the side of the superconducting inductor proximate to the discharging plate A of the capacitor. The superconducting inductor 1 becomes non-magnetic when the electrical charge on the discharging side of the capacitor is depleted causing current to drop off at the inductor. The superconducting inductor, in response to the change in current flow, again resists the change by collapsing the magnetic field and using the stored energy of the magnetic field to push electrons to the charging plate of the capacitor until the superconducting inductor's magnetic field completely collapses and the charging plate B of the capacitor 6 is fully charged. When the system of inductor and capacitor reverse current flow with the fully charged plate B of the capacitor becoming the discharging plate which causes electrons to travel from the discharging plate B of the capacitor 6, through the superconducting inductor to the opposite plate A of the capacitor, now becoming the charging plate, and in response to the change in current flow, the superconducting inductor will again build up stored energy in the form of a magnetic polarity opposite that of the previous cycle so that the system produces an oscillating flow of direct current through the superconducting inductor which becomes a superconducting inductor electromagnet with reversing polarity.

The superconducting inductor 1 and the superconducting wires 2 and 3 when maintained at or below their critical temperature capacity enable a prolonged oscillation of current and prolonged alternating magnetic polarity.

A movable device, supports the permanent magnets 7, 8, and 7A so that the movable device moves in response to the repulsion forces and the attraction forces to create the mechanical motion.

In a preferred embodiment, as shown in FIG. 1, the movable device comprises a slide mechanism, comprising a non-magnetic rod 9 supported on slide bearings contained in permanent magnet assembly supports 10, 11, mounted on a non-magnetic platform 12. A pair of permanent magnets 7, 8 each slidably positioned on the rod 9 on one of two sides of the superconducting inductor electromagnet 1, have a like magnetic pole facing the superconducting inductor electromagnet, in this case North, so that when the polarity on a first side of the superconducting inductor 1 matches the polarity of an adjacent first permanent magnet 7, the first permanent magnet receives a repulsion force to push the first permanent magnet away. Simultaneously, the polarity on the second side of the superconducting inductor 1, in this case South, is opposite in polarity to an adjacent second permanent magnet 8, and the second permanent magnet receives an attraction force to pull the second magnet so that the two forces combine to move the permanent magnets in the same first direction. When the polarity of the superconducting inductor electromagnet 1 reverses, the two forces combine to move the permanent magnets in the same second direction, thereby moving the permanent magnets back and forth in a reciprocating linear mechanical motion as the polarity of the superconducting inductor continually reverses.

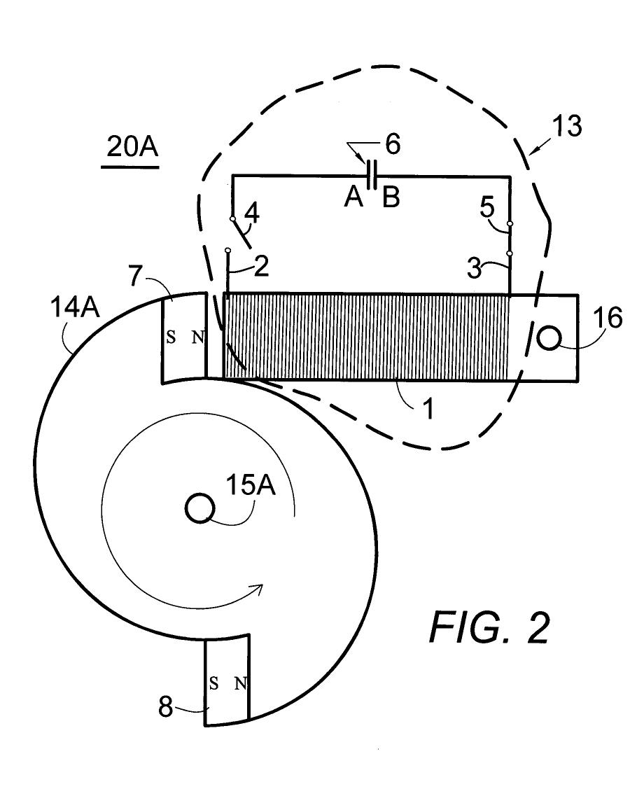

In another embodiment, shown in FIG. 2, the movable device comprises a cyclone shaped rotating mechanism 14A on a central rotating mechanism pivot 15A, having a circular center with at least two opposing elliptical sides spreading out from the circular center so that each opposing elliptical side terminates in a flat face aligned with the diameter of the circular center. A permanent magnet 7, 8 is mounted on each of the two flat faces with different magnetic poles facing outward from adjacent flat faces, so that on flat face, the north polarity is exposed and on the other flat face, the south polarity is exposed. The superconducting inductor assembly 13 is mounted on a superconducting inductor assembly pivot 16 offset from the rotating mechanism pivot 15A with the superconducting inductor assembly 13 aligned perpendicular to the diameter of the rotating mechanism 14A tangent to the circular center. The superconducting inductor 1 is directly facing a first permanent magnet 7 on a first flat face of the rotating mechanism 14A such that the same polarity in the superconducting inductor 1 as in the outward facing polarity of the adjacent permanent magnet 7 creates a repulsion force. The repulsion force causes the rotating mechanism to rotate and the elliptical side to pivot the superconducting inductor assembly 13 up until it falls upon reaching the second flat face of the rotating mechanism 14A. The second permanent magnet 8 on the second flat face of the rotating mechanism has an opposite magnetic polarity facing outward to that of the first permanent magnet. The switching device 4, 5 switches the polarity of the superconducting inductor 1 each time a new permanent magnet is in proximity to and end of the superconducting inductor 1 so that the cyclone shaped rotating mechanism is continually rotated in the same direction producing a continuous rotational mechanical force.

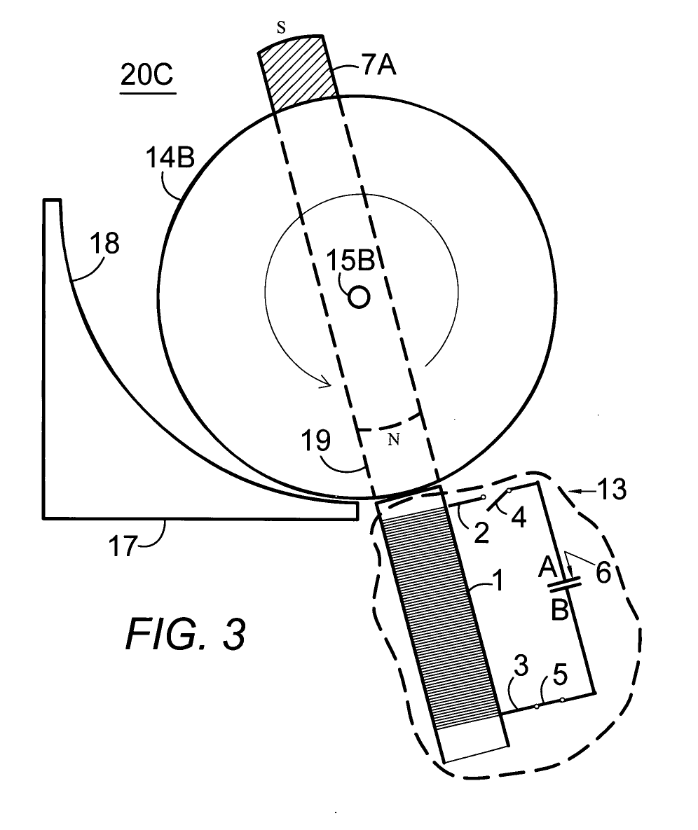

In a third embodiment, as shown in FIG. 3, the rotating mechanism comprises a rotating circular wheel 14B having a central axis pivot 15B, and a slot 19 through the center of the rotating circular wheel 14B along the diameter of the rotating circular wheel. A permanent magnet 7A fitted within the slot 19 of the rotating circular wheel 14B, is permitted to slide freely within the slot 19. The rotating mechanism has means for limiting a protruding end of the magnet 7A protruding out beyond the perimeter of the rotating wheel to less than half the length of the permanent magnet 7A. A re-centering wedge 17 fixed in a stationary position adjacent to the rotating circular wheel 14B, has a convex curved surface 18 facing the rotating circular wheel. The bottom of the curved surface 18 is immediately adjacent to a bottom of the rotating circular wheel and the top of the curved surface is positioned a sufficient distance away from the rotating wheel to allow a fully protruding end of the permanent magnet 7A to contact the upper portion of the curved surface 18 so that as the rotating circular 14B wheel rotates, the curved surface 18 pushes the protruding end of the permanent magnet 7A into the slot by the time the slot reaches the bottom of the rotating circular wheel. The superconducting inductor 1 is mounted below the rotating circular wheel 14B with one end of the superconducting inductor 1 facing upwardly, positioned at an acute angle away from a vertical centerline of the rotating circular wheel 14B, adjacent to the bottom of the re-centering wedge 17 and adjacent to the rotating circular wheel so that as the slot 19 is aligned with the superconducting inductor 1.

The superconducting inductor electromagnet has a magnetic polarity which matches the polarity of the end of the permanent magnet 7A facing the superconducting inductor 1. The repulsion force created by the matching polarities pushes the permanent magnet up into the slot 19 so that the opposite end of the permanent magnet protrudes out the opposite end of the slot adjacent to the top of the rotating circular wheel 14B past the vertical centerline of the rotating circular wheel. The weight of the protruding end of the permanent magnet 7A causes the rotating wheel to turn so that the protruding end of the permanent magnet moves into contact with the curved surface 18 of the re-centering wedge 17 to push the protruding end of the permanent magnet 7A back into the slot 19. The switching device 4, 5 switches the polarity of the superconducting inductor electro-magnet each time an end of the permanent magnet 7A comes into proximity with the upwardly facing end of the superconducting inductor 1, repeatedly pushing the permanent magnet 7A up to protrude outside of the slot 19 to shift the center of the rotating circular wheel 14B weight so that the rotating circular wheel is continually rotated in the same direction, producing a continuous rotational mechanical force.

In use, the present invention is a machine designed to generate mechanical motion utilizing the combined properties of zero resistance and continuous current flow in a superconducting inductor looped wire or coil, the properties of capacitors and inductors when used together in a closed system to oscillate direct current; the properties of inductors to generate stored energy in the form of a magnetic field in response to an influx of current flow and to collapse the magnetic field releasing the stored energy in response to a diminution of current flow, and the properties of like magnetic fields repulsing and opposite magnetic fields attracting.

The preferred embodiment of the present invention comprises a superconducting inductor coil 1 maintained at or below its critical temperature, and two superconducting leads 2, 3 connecting the inductor to a capacitor 6. Bringing the superconducting assembly at or below its critical temperature permits current to flow through the assembly without wire resistance.

The device of the present invention introduces a capacitor 6 and switches 4, 5 to the circuit. The superconducting inducting assembly 13 consists of an inductor 1 constructed of superconducting material, a charged capacitor 6, inductor lead 2 constructed of superconducting material with a switch 4 between the inductor 1 and the capacitor 6, an inductor lead 3 constructed of superconducting material with a switch 5 between the inductor 1 and the capacitor 6. For purposes of this illustration, the left side (switch 4 side) of the capacitor 6 will hold the initial electrical charge and the initial position is open for both switch 4 and switch 5. In this state there is no current flow through the circuit and the energy stored in the form of electrons on the charged plate of the capacitor is static. Closing switches 4 and 5 completes the circuit allowing electrons to discharge from the left plate A of the capacitor 6 through closed switch 4 along inductor lead 2 through the inductor 1, continuing through inductor lead 3, through closed switch 5, to the opposite (charging) plate B of the capacitor. As it does so, the superconducting inductor 1 builds up stored energy in a magnetic field as the inductor resists change to the circuit's flow of electrical current. Once the magnetic field is built, current flows normally through the inductor 1 to the charging plate of the capacitor 6. The magnetic field about the inductor 1 will have its north polarity on the left side (discharging side) of the capacitor 6 and south polarity on the right side (charging side) of the capacitor 6. The inductor 1 becomes an electromagnet.

Once the capacitor 6 has discharged its stored electrons, current on the discharging side of the inductor 1 drops off rapidly. The inductor 1 will resist the change in current flow by collapsing the stored energy built up in the magnetic field, thereby pushing the electrons to the charging plate of the capacitor 6. Once the magnetic field about the inductor 1 has collapsed, the capacitor 6 will be recharged (but with opposite polarity), so it will discharge again through the inductor 1 in the opposite direction. This oscillation of current flow will continue as the superconductor inductor assembly 13 is in persistence state having no energy loss to wire resistance in the superconductor inductor assembly 13 as described above.

The oscillating current and magnetic field of the superconductor inductor assembly 13 described above creates an electromagnet with alternating polarity. The continual motion of this invention is created by placing a permanent magnet 7 on the left side of the superconductor inductor assembly 13 and another permanent magnet 8 on the right side of the superconductor inductor assembly 13. Permanent magnets 7, 8 are placed such that like poles face the superconductor inductor assembly 13. In FIG. 1, the permanent magnets 7, 8 have their north polarity proximate to the superconductor inductor assembly 13. As current oscillates and polarity alternates across the superconductor inductor assembly 13, push/pull forces will be exerted on the permanent magnets 7, 8. The permanent magnets are affixed to a connecting rod 9. The connecting rod 9 connects the permanent magnets to each other by passing through the center of the superconductor inductor 1. In this embodiment the connecting rod 9 is constructed from non-magnetic material. In other embodiments, the permanent magnets 7, 8 can be connected with a connecting mechanism external to and about the superconductor inductor 1. If sufficient distance is maintained between the permanent magnet connecting mechanism and the superconductor inductor 1, the connecting mechanism could be constructed of material influenced by magnetism. To minimize the potential of quench on the superconducting inductor 1 the preferred embodiment uses non-magnetic materials to connect the permanent magnets 7, 8. The connecting rod 9 is held in position by permanent magnet assembly supports 10, 11, which are affixed to a non-magnetic platform 12. The permanent magnet assembly supports 10, 11 are fitted with bearings designed to permit the connecting rod 9 to slide back and forth horizontally along the centerline of the superconductor inductor 1 with little friction, allowing the permanent magnets 7, 8 to piston back and forth in unison as push/pull forces are exerted on the permanent magnets as polarity alternates with the oscillating current of the superconducting inductor assembly 13. Mechanical motion is then derived by combining the persistence state of a superconductive circuit, with oscillating current derived from the combined use of capacitors and inductors in a closed circuit, with the characteristics of inductors forming magnetic fields in response to changes in current flow, and with the characteristic of like magnetic poles repelling and opposite magnetic poles attracting.

A further embellishment on the preferred embodiment introduces a timing device to coordinate the location of the permanent magnets in the “piston” cycle with the oscillating polarity of the superconducting inductor 1 to maximize the push/pull magnetic forces generated between superconductor inductor assembly 13 and the permanent magnets 7, 8. To regulate the speed of the mechanical motion generated by regulating the cycle speed of the superconductor inductor assembly 13, a device similar to a distributor would be introduced to control the position of the switches 4, 5. During capacitor discharge, both switches are closed completing the circuit. Momentarily after the capacitor discharges, the switch on the discharging side of the circuit opens preventing reverse flow of current. The stored energy in the inductor will maintain current flow to the charging side of the capacitor until the magnetic field collapses forcing electrons to the capacitor's charging side. With the circuit open, the system is in a static energy state with electrons stored on one plate of the capacitor. When the permanent magnet assembly is in the optimum position to be attracted/pushed in the opposite direction, the open switch closes, completing the circuit, thereby allowing the charged side of the capacitor 6 to discharge through the superconductor inductor 1 to be opposite side of the capacitor. Momentarily after the capacitor 6 discharges, the switch on the discharging side of the circuit opens preventing reverse flow of current until needed.

The permanent magnets 7, 8 as described above can be replaced with superconducting electromagnets in persistence state. Permanent magnets are the preferred embodiment as it is this portion of the mechanism which is in constant motion.

It is understood that the preceding description is given merely by way of illustration and not in limitation of the invention and that various modifications may be made thereto without departing from the spirit of the invention as claimed.

What is claimed is:

1. A motor device for generating continuous mechanical motion from the interaction of a combination of components, the device comprising in combination:
a superconducting inductor constructed of superconducting wires kept at or below their critical temperature;
superconducting wires connected to the superconducting inductor to form two leads from the superconducting inductor, the superconducting wires kept at or below their critical temperature;
a charged capacitor inserted between and connecting the two leads of the superconducting inductor creating a continual oscillation of direct electrical across the inductor to form a superconducting inductor electromagnet with alternating magnetic polarity, the charged capacitor, superconducting wires and superconducting inductor together forming a superconducting circuit;
at least one permanent magnet supported on a movable device with the at least one permanent magnet placed in proximity to the alternating magnetic polarity of the superconducting inductor electromagnet, thereby causing repulsion forces between like magnetic poles of the at least one permanent magnet and the superconducting inductor electromagnet and attraction forces between opposite magnetic poles of the at least one permanent magnet and the superconducting inductor electromagnet, the repulsion forces and attraction forces harnessed to perform mechanical motion so that the movable device moves in response to the repulsion forces and the attraction forces to create the mechanical motion; and
at least one switching device inserted into the superconducting circuit to coordinate the alternating polarity of the superconducting inductor electromagnet with the proximity of the at least one permanent magnet.

2. The device of claim 1 wherein the charged capacitor comprises two charging plates, and the at least one switching device comprises a switching control for two switches, one connected to each of the two leads, the switching control activated to cause a charged plate of the capacitor to become a discharging plate to discharge current through the superconducting inductor to the opposite plate of the capacitor which becomes a charging plate and the superconducting inductor resists the changes in current flow and builds up stored energy in the form of a magnetic field as current begins to flow through the superconducting inductor, and once the magnetic field is built, current flows normally through the superconducting inductor to the opposite charging plate of the capacitor and the inductor becomes a superconducting inductor electromagnet with north polarity being formed on the side of the superconducting inductor proximate to the discharging plate of the capacitor, wherein the superconducting inductor becomes non-magnetic when the electrical charge on the discharging plate of the capacitor is depleted causing current to drop off at the superconducting inductor, wherein the superconducting inductor in response to the change in current flow again resists the change by collapsing the magnetic field and using the stored energy of the magnetic field to push electrons to the charging plate of the capacitor until the superconducting inductor's magnetic field completely collapses and the charging plate of the capacitor is fully charged, when the system of superconducting inductor and capacitor reverse current flow with the fully charged plate of the capacitor becoming the discharging plate which causes electrons to travel from the discharging plate of the capacitor, through the superconducting inductor to the opposite plate of the capacitor, now becoming the charging plate, and in response to the change in current flow, the superconducting inductor will again build up stored energy in the form of a magnetic polarity opposite that of the previous cycle so that the system produces an oscillating flow of direct current through the superconducting inductor which becomes an oscillating superconducting inductor electromagnet with reversing polarity.

3. The device of claim 2 wherein the superconducting inductor and the superconducting wires when maintained at or below their critical temperature capacity enable a prolonged oscillation of current and prolonged alternating magnetic polarity.

4. The device of claim 1 wherein the movable device comprises a slide mechanism.

5. The device of claim 4 wherein the slide mechanism comprises a rod supported on slide bearings and the at least one permanent magnet comprises a pair of permanent magnets each slidably positioned on the slide mechanism positioned on one of two sides of the superconducting inductor electromagnet, each of the permanent magnets having a similar magnetic pole facing the superconducting inductor electromagnet so that when a first polarity on a first side of the superconducting inductor matches the polarity of an adjacent first permanent magnet, the first permanent magnet receives a repulsion force to push the first permanent magnet away and at the same time the second polarity on the second side of the superconducting inductor is opposite in polarity to an adjacent second permanent magnet, the second permanent magnet receives an attraction force to pull the second magnet so that the two forces combine to move the permanent magnets in the same first direction, and when the polarity of the superconducting inductor electromagnet reverses, the two forces combine to move the permanent magnets in the same second direction, thereby moving the permanent magnets back and forth an a reciprocating linear mechanical motion as the polarity of the superconducting inductor continually reverses.

6. The device of claim 3 wherein the movable device comprises a rotating mechanism.

7. The device of claim 6 wherein the rotating mechanism comprises a cyclone shaped rotating mechanism on a central rotating mechanism pivot having a circular center with at least two opposing elliptical sides spreading out from the circular center so that each opposing elliptical side terminates in a flat face aligned with the diameter of the circular center and the at least one permanent magnet comprises a permanent magnet mounted on each of the at least two flat faces with different magnetic poles facing outward from adjacent flat faces; and the superconducting inductor electro-magnet is mounted on an electromagnet pivot offset from the rotating mechanism pivot with the superconducting inductor electromagnet aligned perpendicular to the diameter of the rotating mechanism tangent to the circular center so that the superconducting inductor electromagnet is directly facing a first permanent magnet on a first flat face such that the same polarity in the superconducting inductor electro-magnet as in the outward facing polarity of the adjacent permanent magnet creates a repulsion force causing the rotating mechanism to rotate and the elliptical side to pivot the superconducting inductor electromagnet up until it falls upon reaching the second flat face with the second permanent magnet having an opposite magnetic polarity facing outward to that of the first permanent magnet, the at least one switching device switches the polarity of the superconducting inductor electromagnet each time a new permanent magnet is in proximity to the superconducting inductor electromagnet so that the cyclone shaped rotating mechanism is continually rotated in the same direction producing a continuous rotational mechanical force.

8. The device of claim 6 wherein the rotating mechanism comprises a rotating circular wheel having a central axis pivot and a slot through the center of the wheel a diameter of the wheel and a permanent magnet fitted within and being permitted to slide freely within the slot of the rotating wheel with a means for limiting a protruding end of the magnet protruding out beyond the perimeter of the rotating wheel to less than half the length of the permanent magnet; a re-centering wedge fixed in a stationary position adjacent to the rotating wheel, the re-centering wedge comprising a convex curved surface facing the rotating wheel with a bottom of the curved surface immediately adjacent to a bottom of the rotating wheel and a top of the curved surface positioned a sufficient distance away from the rotating wheel to allow a fully protruding end of the permanent magnet to contact the upper portion of the curved surface so that as the rotating wheel rotates the curved surface pushes the protruding end of the permanent magnet into the slot by the time the slot reaches the bottom of the rotating wheel; and the superconducting inductor is mounted below the rotating circular wheel with an end of the superconducting inductor facing upwardly positioned at an acute angle away from a vertical centerline of the rotating wheel adjacent to the bottom of the re-centering wedge and adjacent to the rotating wheel so that as the slot is aligned with the superconducting inductor electro-magnet, the superconducting inductor electromagnet has a magnetic polarity which matches the polarity of the end of the permanent magnet facing the superconducting inductor, the repulsion force pushes the permanent magnet up into the slot so that an opposite end of the permanent magnet protrudes out the slot adjacent to a top of the rotating wheel past the vertical centerline of the rotating wheel shifting the center of the rotating wheel weight to the opposite side of rotating wheel causing the rotating wheel to turn so that the protruding end of the permanent magnet moves into contact with the curved surface of the re-centering wedge to push the permanent magnet back into the slot; the at least one switching device switches the polarity of the superconducting inductor electromagnet each time a new end of the permanent magnet is in proximity to the superconducting inductor electromagnet repeatedly pushing the permanent magnet up to protrude outside of the slot to shift the center of the rotating wheel weight so that the rotating wheel is continually rotated in the same direction producing a continuous rotational mechanical force.
